(19) United States
(12) Patent Application Publication
(10) Pub. No.: US 2024/0394586 A1
(43) Pub. Date: Nov. 28, 2024

(54) ORCHESTRATION OF QUBO JOBS BETWEEN GATE-BASED QUANTUM COMPUTERS AND QUANTUM ANNEALERS

(71) Applicant: Dell Products L.P., Round Rock, TX (US)

(72) Inventors: Rômulo Teixeira de Abreu Pinho, Niterói (BR); Michael Robillard, Shrewsbury, MA (US); Benjamin E. Santaus, Somerville, MA (US); Brendan Burns Healy, Haddonfield, NJ (US); Victor Fong, Medford, MA (US); Miguel Paredes Quiñones, Campinas (BR)

(21) Appl. No.: 18/321,526

(22) Filed: May 22, 2023

(51) Int. Cl. G06N 10/80; G06N 10/20

(52) U.S. Cl. CPC G06N 10/80; G06N 10/20

(57) ABSTRACT

One example method includes obtaining information about a first pre-defined implementation of a QUBO (quadratic unconstrained binary optimization) problem configured for execution on a gate-based device, obtaining information about a second pre-defined implementation of the QUBO problem configured for execution on an annealing device, receiving information about a QUBO job that is to be executed, identifying first hardware and second hardware that are available to execute the QUBO job, and the first hardware is different from the second hardware, using the information about the first and second pre-defined implementations of the QUBO problem to generate respective predictions concerning performance of the QUBO job on the first hardware and the second hardware, comparing the predictions, and based on the comparing, selecting one of the first hardware and the second hardware for execution of the QUBO job.

### FIELD OF THE INVENTION

Embodiments of the present invention generally relate to orchestration of QUBO jobs. More particularly, at least some embodiments of the invention relate to systems, hardware, software, computer-readable media, and methods, for execution of QUBO jobs on a heterogeneous computing infrastructure.

### BACKGROUND

QUBO (quantum unconstrained binary optimization) problems, or QUBO jobs, can be solved in quantum computers using general-purpose gate-based quantum algorithms and quantum annealing formulations, whether on real quantum hardware or on quantum simulation engines running on classical devices. Each approach has advantages and disadvantages related to various considerations. Such considerations, which may vary significantly between different devices and types of devices, may include, for example, the quality of the obtained solutions, execution times, and overall resource usage, both quantum and classical, as well as the cost to obtain the solutions. Thus, deciding where to run such QUBO jobs, given some heterogenous infrastructure, is a problem in quantum workload orchestration.

At present, some QUBO problems are implemented and executed directly on a pre-selected architecture. In this context, special knowledge is required about how to translate the problems into the configurations supported by that architecture. For example, even among annealers, quantum annealers may require a beta range, while classical and simulated annealers will not. Thus, there is no way for a general user to simply submit an optimization job, such as a QUBO, in a way that is decoupled from the architecture. In addition, general users and specialists cannot benefit from a heterogenous infrastructure in a transparent fashion given execution, or SLO (service level objective) constraints related to solution quality, resource usage, and cost, for example.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example optimization problem.

FIG. 2 discloses aspects of an example quantum annealing workflow.

FIG. 3 discloses aspects of an example embedding problem.

FIG. 4 discloses performance aspects of some example annealers.

FIG. 5 discloses aspects of an architecture according to one embodiment.

FIG. 6 discloses aspects of a method according to one embodiment.

FIG. 7 discloses aspects of a computing entity configured and operable to perform any of the disclosed methods, processes, and operations.

### DETAILED DESCRIPTION OF SOME EXAMPLE EMBODIMENTS

Embodiments of the present invention generally relate to orchestration of QUBO jobs. More particularly, at least some embodiments of the invention relate to systems, hardware, software, computer-readable media, and methods, for execution of QUBO jobs on a heterogeneous computing infrastructure.

In one example embodiment of the invention, a function is defined that specifies a set of variables encoded in a QUBO problem, such as in the form of a QUBO matrix, a set of constraints to be satisfied in the optimization, that is, in the solution of the QUBO, and SLO constraints to be satisfied by the job orchestrator. The function, which may be called by a human developer or by a computing entity, may also specify a set of implementation-specific parameters. In one embodiment, the invocation of the function may be used to obtain various pre-defined architecture-specific QUBO jobs based on the QUBO matrix, such as by an orchestrator for example, where each implementation corresponds to a respective infrastructure. The orchestrator may then be queried to identify, for example, the best infrastructure of each type of infrastructure, such as in terms of SLO compliance for example, to run the QUBO job. In an embodiment, the identified infrastructures may comprise, for example, a gate-based device, and an annealing device. As among the identified infrastructures, the infrastructure that best satisfies the SLO constraints may be selected, and the QUBO job then orchestrated to the selected infrastructure for execution.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that a QUBO job may be orchestrated to, and executed on, a heterogeneous infrastructure, comprising various dissimilar parts or elements, without requiring an orchestrator or user to have any knowledge about those underlying elements, or configuration, of the infrastructure. An embodiment may enable orchestration of a QUBO job to a particular infrastructure, based solely on the ability of that infrastructure to meet SLO requirements. Various other advantages of one or more embodiments of the invention will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Context for an Example Embodiment

Following is a brief discussion concerning various concepts that may relate to one or more embodiments. This discussion is not intended to limit the scope of the invention in any way.

In general, quantum annealers include computational devices configured to solve combinatorial optimization problems, such as QUBO optimization problems. A QUBO model may be expressed by an optimization problem, thus:

QUBO: minimize the function y=x^{t}Qx, where,
x is a vector of binary decision variables, and
Q is a matrix of constants sometimes referred to as a QUBO matrix.

QUBO problems are a type of combinatorial optimization problem such that many real world problems may be encoded in the format (where x∈{0,1}ⁿ):

$$H ( x ) = {\sum }_{i < j} {q}_{i , j} {x}_{i} {x}_{j} + {\sum }_{i} {q}_{i} {x}_{i}^{2} = {x}^{T} Qx$$

Quantum annealing (QA) processes may attempt to interpolate between a static problem-independent Hamiltonian for which the ground state may be efficiently prepared, and a final Hamiltonian whose ground state yields the desired answer. The QA system then linearly interpolates between H₀ and H_{f}(H_{f}=Q).

$$H ( t ) = α ( t ) {H}_{0} + β ( t ) {H}_{f}$$

Where: H_{f} is the Hamiltonian of the problem that is to be solved. This system represented by H(t) evolves following the time-dependent Schrodinger equation. The system is manipulated in the manner of create quantum tunneling effect that makes that the system stay closer to the ground state.

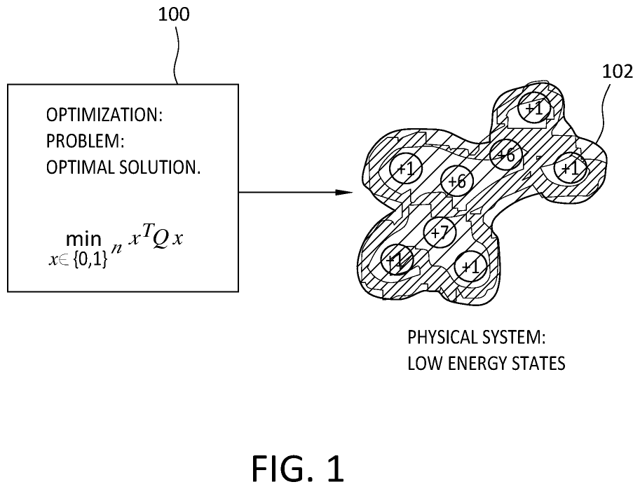

With the foregoing in view, attention is directed to FIG. 1 which discloses an example quantum annealing intuition. Particularly, FIG. 1 discloses an optimization problem solution 100 expressed in terms of, or modeled as, low energy states of a physical system 102.

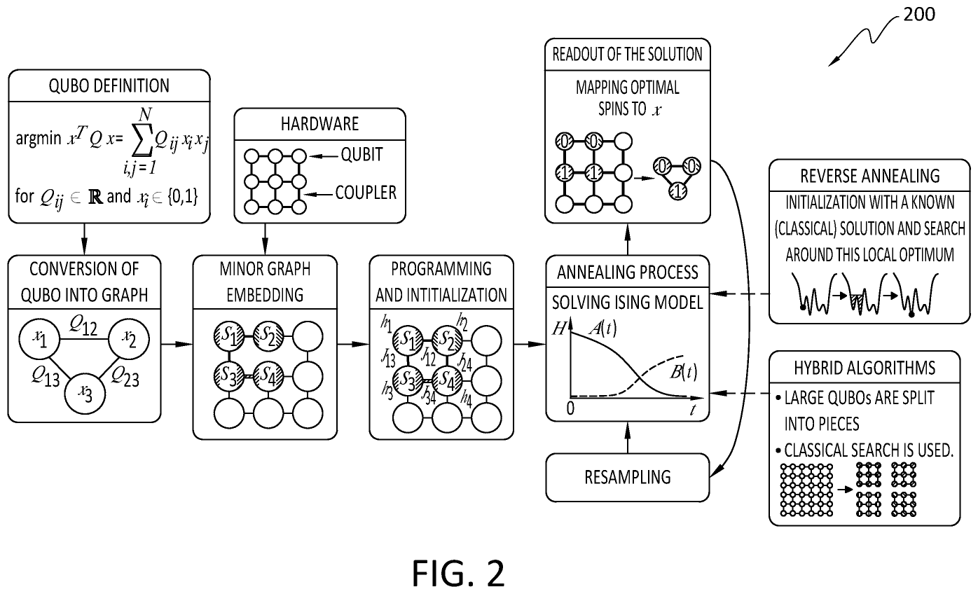

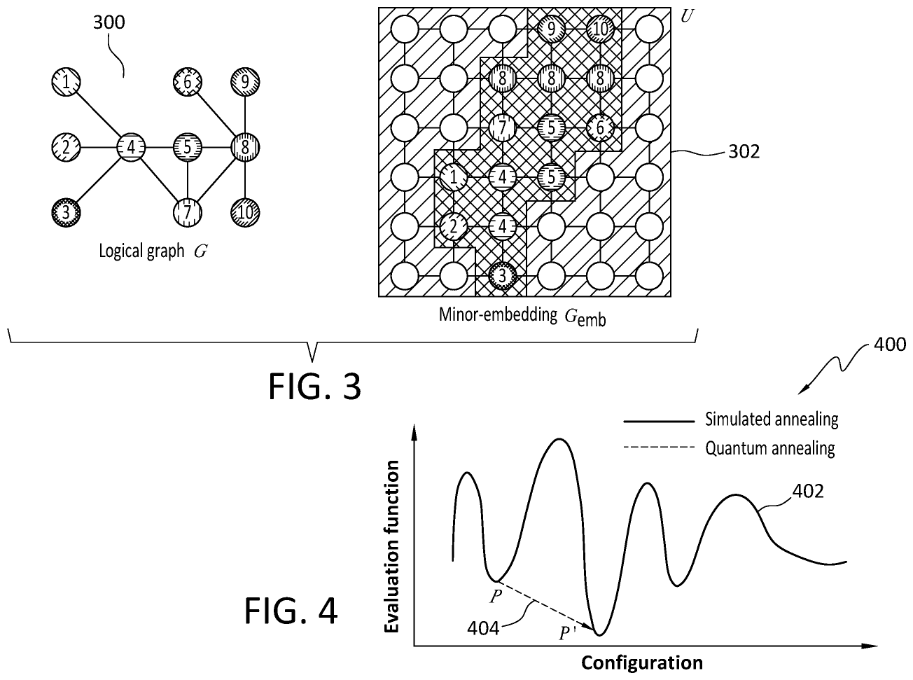

Turning next to FIG. 2, there is discloses an example quantum annealing workflow 200. As shown there, for example, a quantum annealing workflow 200 may involve a minor graph embedding problem, an example of which is disclosed in more detail in FIG. 3.

Particularly, FIG. 3 discloses a logical graph G 300 whose various nodes are to be mapped to qubits implemented in hardware, as shown at 302. Thus, a minor embedding problem may be expressed as the need to map graph nodes to the qubits implemented in the hardware, in order to solve combinatorial optimization problems. In practice, heuristics are used. However, weak embeddings may drastically reduce the number of qubits available for computation, which may prevent the resolution of larger problem instances.

With reference next to FIG. 4, a graph 400 is disclosed that indicates respective behaviors of a simulated annealing process 402, and a quantum annealing process 404. As used herein, simulated quantum annealing (SQA) refers, but is not limited, to computational techniques used to simulate the environment of QA. SQA may be performed using classical computing, such as OpenJiJ for example, classical accelerators such as NEC Corp. vector engine that performs simulated annealing, or by creating specialized hardware, such as a digital annealer created by Fujitsu Corp., for simulating the behavior of QA.

As used herein, Simulated Annealing (SA) is a metaheuristic, resembling in some respects, and by way of analogy, an annealing process on metallurgy, where, in the analogy, a QUBO can be encoded on the process of controlled cooling, that is, annealing, of a metal. SA can provide good solutions for a large range of problems, but there is evidence that QA may be able find the global minimum/minima of some problems exponentially more quickly than SA would be able to. Thus, whether or not QA and/or SA are used may depend on the particular circumstances involved. Finally, it is noted that while QA can use quantum tunneling to escape local minima, that approach is unavailable to SA processes.

### B. Aspects of an Example Architecture and Operations

An example embodiment of the invention may perform, or cause the performance of, the execution of optimization jobs, such as QUBO jobs, on a heterogeneous infrastructure in a transparent fashion. Following is a discussion of aspects of an example architecture, and associated operations, according to one embodiment of the invention. This discussion is not intended to limit the scope of the invention, or the applicability of the embodiments, in any way.

### B.1 Orchestrator/Orchestration Overview

As discussed in more detail below, an embodiment of the invention may involve the use of one or more orchestrators. In general, an orchestrator may operate to assign an incoming QUBO job to particular hardware, of a heterogeneous computing infrastructure, on which the QUBO job will be run. This assignment may be made based on an estimate, by the orchestrator, as to how a particular implementation of that QUBO job might be expected to run on that particular hardware. Such estimates, or predictions, may be performed by a trained machine learning model using as input, for example, metadata about the QUBO job itself. As well, the trained machine learning model may use, as input, telemetry including, for example, any information, data, and metadata, concerning the execution various of problems on different types of hardware, resource consumption information such as memory usage, cost to obtain a QUBO problem solution, time for execution of one or more QUBO problems, and fidelity of the QUBO solutions obtained. In one embodiment, the telemetry information may comprise one or more SLO parameters.

To illustrate with an example, consider an architecture that includes two orchestrators, one for gate-based quantum HW only and the other for quantum annealing HW only. Each of these orchestrators can run QUBO jobs, because there are known to exist implementations of QUBO algorithms for both gate-based and annealing quantum computers. An orchestration layer, or orchestrator, according to one example embodiment effectively encapsulate these two orchestrators. In this illustrative example, when the orchestrator receives a new QUBO job to run, it may transparently decide which of the two types of HW, that is, gate-based or annealing, is the best option, such as in terms of SLO compliance for example.

In an embodiment, this decision and selection process may be performed by the orchestrator as follows. In particular, each of one or more orchestrators may comprise prediction functionality, such as by inclusion of the trained machine learning model referred to above. This prediction functionality may use metadata about the QUBO job to generate respective predictions as to how the job would run on any of the platforms managed by the orchestrator. Thus, for example, a gate-based orchestrator may have access to many different gate-based hardware configurations, and the gate-based orchestrator may thus be able to estimate how the job would run on any of those gate-based hardware configurations. In a similar manner, an annealing orchestrator has access to various different annealing hardware, and may thus be able to estimate how the job would run on any of those annealing hardware configurations. The underlying orchestrators, for the various respective hardware types, may now decide, for the hardware to which it has access, which of those pieces of hardware is the best option to run the QUBO job. Thus, the gate-based orchestrator may pick the best gate-based hardware, while the annealing orchestrator may pick the best annealing hardware. In an embodiment, these orchestrators may then expose those two selections to an orchestration layer, together with the execution estimates, so that the orchestration layer can decide where to place the new QUBO job. Once the orchestration layer makes this decision, it can then pass the QUBO job to the appropriate underlying orchestrator to actually execute the QUBO job. Note that the orchestration decision may be made based entirely on estimations or predictions as to how the QUBO job might be expected to run on particular hardware, and the QUBO job may not actually be run until it is placed on particular hardware.

### B.2 Example Architecture

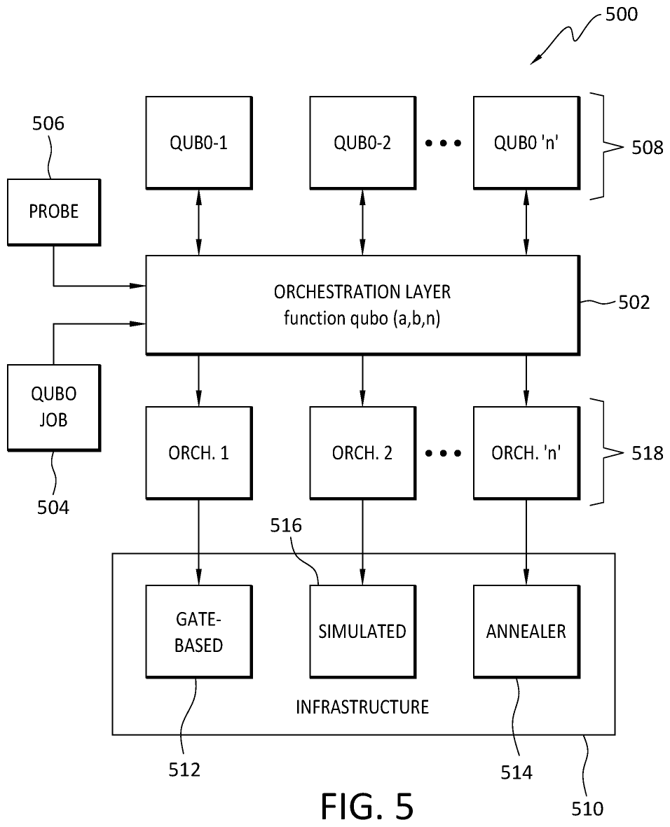

With particular attention now to FIG. 5, one example of an architecture according to one example embodiment is denoted generally at 500. As shown, an orchestration layer 502 may execute a function: qubo(a, b, n), where ‘a,’ ‘b,’ and ‘n’ each correspond with a respective aspect or element of a QUBO problem 504. Any number of elements may be specified for this example function. In an embodiment, the set of elements may take the form of, or be transformed into, a QUBO matrix that corresponds to a QUBO problem. In one example embodiment, the qubo function may take the following form: qubo (variables, constraints, objective, SLO, parameters). Thus, in this illustrative example, the qubo function specifies the set of variables of the QUBO problem 504 in the form of a QUBO matrix, namely, [1] a set of constraints to be satisfied in the optimization, [2] SLO constraints to be satisfied by the job orchestrator, and [3] implementation-specific parameters. Such SLO constraints, for example, may comprise resource consumption information such as memory usage, cost to obtain a QUBO problem solution, and time for execution of the QUBO problem.

### B.3 Pre-Defined QUBO Problem Implementations

Upon execution of the function, which may be performed in response to a probe 506, the orchestrator 502 may access information, such as metadata for example, about hardware and software of various pre-defined implementations 508 of a QUBO problem. In general, each of the pre-defined QUBO problem implementations 508 may comprise a respective pre-defined implementation of the QUBO problem that corresponds with a particular infrastructure. In more detail, a pre-defined QUBO implementation refers to the fact that for a single problem definition, such as for the QUBO job 504, there may be any number of different ways of generating solutions to that single problem, depending on the hardware and software used to solve the problem. For example, an embodiment of the invention may involve the use of gate-based quantum computers and annealers, and those devices may have various different software packages that may be used to run a job. Thus, each different combination of hardware/software, that is, each ‘implementation,’ defines a respective approach that may be selected to solve a particular problem. As such, in one embodiment, the QUBO problem implementations 508 need not be created or defined, that is, the QUBO problem implementations 508 may be pre-existing in such an embodiment, and information about them may then be accessed as a result of the execution of the function at, and by, the orchestration layer 502.

In an embodiment, the pre-defined QUBO problem implementations 508 may take various forms. Information about these pre-defined QUBO problem implementations 504 may be accessed by the orchestration layer 502 individually, or as a group. As discussed above, each pre-defined QUBO problem implementation 508 may comprise a respective algorithm corresponding to an element of a heterogeneous infrastructure 510. That is, and as noted earlier herein, a pre-defined QUBO implementation may comprise a defined combination, of particular hardware and software, that may be capable of running a QUBO job, such as the QUBO job 504. For example, one pre-defined QUBO problem implementation 508 may correspond to a gate-based portion 512 of the infrastructure 510, which may comprise, for example, a quantum hardware device such as a QPU (quantum processing unit) or may comprise a gate-based device which may take the form of real hardware, or a simulation engine, for example. In an embodiment, a simulation engine simulates, on classical computing hardware, the operation of quantum computing hardware.

Another pre-defined QUBO problem implementation 508 may correspond to an annealer portion 514 of the infrastructure 510, which may comprise a quantum annealing device for example, of the infrastructure 510, and still another pre-defined QUBO problem implementation 508 may correspond to a simulated element 516 of the infrastructure 510, such as a simulated annealing device for example, of the infrastructure 506. As shown in FIG. 5, and discussed in more detail below, the orchestration layer 502 may communicate with one or more orchestrators 518 for the placement of QUBO jobs on hardware of the infrastructure 510.

Thus, execution of the qubo function by the orchestration layer 502, which may be performed in response to the probe 506, may cause the accessing, by the orchestrator 502, information concerning any or all of the following pre-defined QUBO problem implementations 508: [1] a pre-defined implementation of the QUBO problem on a gate-based quantum device, such as a quantum circuit for example—in an embodiment, the pre-defined QUBO implementation 508 may be stored in, and retrieved from, a repository; [2] a pre-defined implementation of the QUBO problem 508 on a quantum annealing device in the form of an actual execution device graph, such as may be generated in connection with a minor embedding problem; and [3] a pre-defined implementation of the QUBO problem 508 on a simulated annealing device which, in one embodiment, may be fully connected and not require a solution to minor embedding. Note that the particular pre-defined QUBO implementations 508 referenced in a particular embodiment may be a function, at least in part, of the particular QUBO job 504.

### B.4 Hardware Identification

After information about the various pre-defined QUBO implementations 508 has been obtained by the orchestration layer 502, the orchestration layer 502, and/or the individual orchestrators 518, may then use that information, along with information about the new QUBO job 504, to generate respective predictions as to how the QUBO job 504 may be expected to run on the various different hardware/software configurations, 512, 514, and 516, of the infrastructure 510. In more detail, and as shown in FIG. 5, each of the orchestrators 518 may, for the respective hardware of the infrastructure 510, that is available to that orchestrator 518, generate a prediction as to how the QUBO job 504 may be expected to run on that hardware. Based on these predictions, each of the orchestrators 518 may then determine, as among the various hardware available to it, which hardware would be expected to perform the QUBO job 504 in a way that most closely conforms with specified criteria, such as SLO requirements for example.

With continued reference to FIG. 5, and after each of the orchestrators 518 has respectively identified the best performing hardware accessible to it, the orchestrators 518 may then provide that information to the orchestration layer 502. For example, the orchestrators 518 may expose that information, along with related information, such as execution time estimates and resource consumption estimates, to the orchestration layer 502. In further detail, this related information may comprise telemetry, examples of which are discussed elsewhere herein. In one embodiment, such telemetry may comprise execution metrics, which may be estimated for different hardware of the infrastructure 510, so as to enable SLO optimization for example. Example methods for estimation of execution metrics are disclosed in U.S. patent application Ser. No. 18/321,207, entitled ESTIMATING EXECUTION METRICS OF DIFFERENT ANNEALERS FOR SLO OPTIMIZATION, filed May 22, 2023 and incorporated herein in its entirety by this reference. At this point, the orchestration layer 502 then has the information it needs to make a QUBO job 504 placement, or orchestration, decision.

That is, the orchestrators 518 may have collectively identified, for a specific QUBO job 504, the gate-based device, and the annealing device, of the infrastructure 510 that are expected to provide the best performance with regard to execution of the QUBO job 504. Note that in an embodiment, ‘best-performing’ is made in reference to which of the devices performs in a way that best satisfies, among the devices, the requirements of an SLO. However, ‘best-performing’ may be assessed with reference to additional, or alternative, requirements, and the scope of the invention is not limited solely to consideration of SLO requirements in assessing device performance. Note that the best-performing device for one particular QUBO job may not necessarily be the best-performing device for another, different, QUBO job.

### B.5 Orchestration

After the best-performing devices of the infrastructure 510 have been identified, a selection of one of those devices, for running the QUBO job 504, may be made. In an embodiment, the best-performing device may be a gate-based device, or an annealing device. In particular, the orchestration layer 502 may, in one embodiment, compare the performance, as may be expressed by performance predictions, of the best-performing gate-based device with the performance of the best-performing annealing device. Whichever of these two devices exhibits the best overall performance may be selected by the orchestration layer 502, and the QUBO job 504 orchestrated to, the corresponding orchestrator 518 by the orchestration layer 502. The selected device may comprise an element of an infrastructure 510 that may be located in whole or in part on-premises at a business enterprise, or may be located in whole or in part off-premises, such as in a cloud computing environment for example. In one embodiment, the orchestration method may comprise an intelligent orchestration of hybrid quantum-classical workloads, one or more examples of which are disclosed in U.S. patent application Ser. No. 17/648,065, entitled INTELLIGENT ORCHESTRATION OF HYBRID QUANTUM-CLASSIC WORKLOADS, and incorporated herein in its entirety by this reference.

### C. Further Discussion

As will be apparent from this disclosure, one or more embodiments of the invention may possess various useful features and aspects. For example, an embodiment may comprise a method that comprises the transparent orchestration of QUBO optimization jobs across a heterogeneous infrastructure comprising gate-based quantum computers and quantum annealing devices. As another example, an embodiment may comprise a high-level API (application program interface) that enables general users and specialists to execute QUBO jobs without requiring any knowledge, on the part of the users, about the underlying infrastructure where the QUBO jobs are executed, while satisfying SLO constraints. That is, a method according to one embodiment may enable the execution of QUBO jobs in a way that is agnostic with respect to the underlying hardware infrastructure. As a final example, an embodiment of the invention may comprise a method and mechanism that operate to identify and obtain the, predicted, best-performing gate-based and annealing devices that are expected to best satisfy the provided SLO constraints.

### D. Example Methods

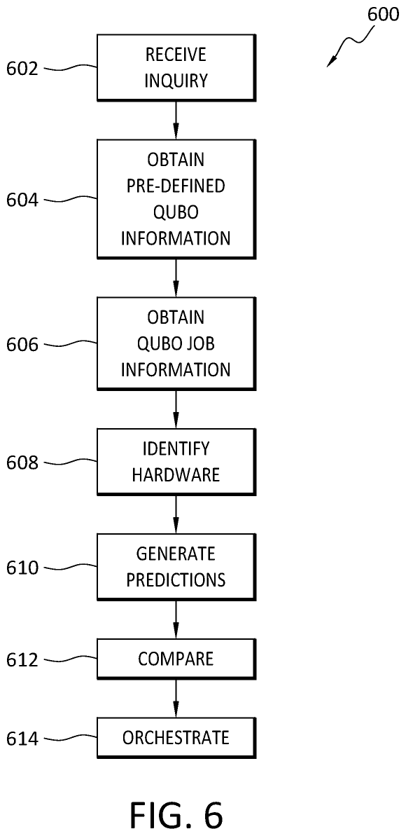

It is noted with respect to the disclosed methods, including the example method of FIG. 6, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 6, a method according to one example embodiment is generally denoted at 600. In an embodiment, part, or all, of the example method 600 may be performed by, and/or at the direction of, an orchestration layer and/or one or more orchestrators. However, no particular functional allocation among computing entities is required in any embodiment.

The method 600 may begin with receiving 602 an inquiry, or probe, with regard to hardware for performing a particular QUBO job. In response to the inquiry 602, various information, such as metadata, may be obtained 604 concerning one or more pre-defined QUBO job implementations. These pre-defined QUBO job implementations may comprise, for example, pre-defined QUBO job implementations concerning, respectively, a gate-based device, a quantum annealing device, and/or a simulated quantum annealing device.

After the information about the pre-defined QUBO job implementations has been obtained, possibly from a repository for example, information about a new, or incoming, QUBO job may be obtained 606. Hardware that is expected to be available to run the QUBO job may then be identified 608, such as by respective orchestrators for example.

The information about the new QUBO job, as well as information about the pre-defined QUBO job implementations, may then be used to generate predictions 610 as to how the identified hardware may be expected to perform when running the new QUBO job. In an embodiment, the predictions may be generated by a trained machine learning model, or respective trained machine learning models at different orchestrators.

When the hardware performance predictions have been obtained 610, a comparison may then be performed 612 of the respective predicted performances of the hardware. In one embodiment, a result of the comparison 612 may be an identification of a best-performing gate-based hardware, and a best-performing annealer. The best performing device may then be selected, and the QUBO to be solved may then be orchestrated 614 to that device for execution.

Thus, an embodiment may use predicted performances to make orchestration decisions concerning QUBO problems. That is, an orchestration decision for a QUBO job may be made without requiring the QUBO job to be run beforehand, that is, before the orchestration decision is made.

### E. Further Example Embodiments

Following are some further example embodiments of the invention. These are presented only by way of example and are not intended to limit the scope of the invention in any way.

Embodiment 1. A method, comprising: obtaining information about a first pre-defined implementation of a QUBO (quadratic unconstrained binary optimization) problem configured for execution on a gate-based device; obtaining information about a second pre-defined implementation of the QUBO problem configured for execution on an annealing device; receiving information about a QUBO job that is to be executed; identifying first hardware and second hardware that are available to execute the QUBO job, and the first hardware is different from the second hardware; using the information about the first and second pre-defined implementations of the QUBO problem to generate respective predictions concerning performance of the QUBO job on the first hardware and the second hardware; comparing the predictions; and based on the comparing, selecting one of the first hardware and the second hardware for execution of the QUBO job.

Embodiment 2. The method as recited in any preceding embodiment, wherein the first hardware comprises a gate-based device operable to execute a quantum circuit.

Embodiment 3. The method as recited in any preceding embodiment, wherein the second hardware comprises an annealing device that comprises a quantum annealing device, or a simulated annealing device.

Embodiment 4. The method as recited in any preceding embodiment, wherein the first hardware and the second hardware are both elements of a single heterogeneous computing infrastructure.

Embodiment 5. The method as recited in any preceding embodiment, wherein each of the pre-defined QUBO problems defines a different respective combination of hardware and software.

Embodiment 6. The method as recited in any preceding embodiment, wherein each of the predictions indicates how closely the respective performances of the QUBO job conform with one or more requirements of a service level objective.

Embodiment 7. The method as recited in any preceding embodiment, wherein the QUBO job is orchestrated to whichever of a gate-based device, or an annealing device, exhibits the better predicted performance of the QUBO job.

Embodiment 8. The method as recited in any preceding embodiment, wherein the first hardware comprises an annealing device in a form of either a real quantum computing hardware, or a simulation engine operable to simulate quantum computing hardware.

Embodiment 9. The method as recited in any preceding embodiment, wherein the second hardware comprises a gate-based device in a form of either real quantum computing hardware, or a simulation engine operable to simulate quantum computing hardware.

Embodiment 10. The method as recited in any preceding embodiment, wherein the selecting of the hardware is performed in response to invocation of a function that specifies a set of elements of the QUBO job, and the elements of the QUBO problem comprise [1] a set of constraints to be satisfied in an optimization of a solution to the QUBO job, and [2] service level objective constraints.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed. In an embodiment, a computer and computing system may comprise quantum computing hardware, classical computing hardware, or a combination of the two. Quantum computing hardware may comprise, but is not limited to, annealers or annealing devices, gate-based quantum devices such as in the form of a quantum circuit, and real quantum hardware. Other hardware comprises a simulation engine, such as a simulated annealing device, that simulates actual hardware and is operable to obtain a resolution to a problem such as a QUBO for example. Other annealers or annealing devices may comprise classical computing hardware and/or quantum computing hardware.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

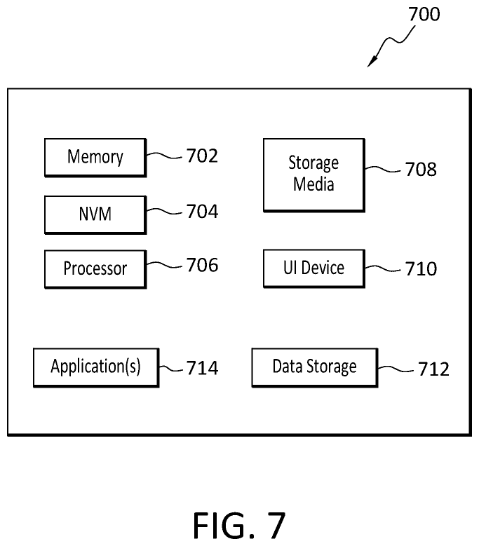

With reference briefly now to FIG. 7, any one or more of the entities disclosed, or implied, by FIGS. 1-6, and/or elsewhere herein, may take the form of, or include, or be implemented on, or hosted by, a physical computing device, one example of which is denoted at 700. As well, where any of the aforementioned elements comprise or consist of a virtual machine (VM), that VM may constitute a virtualization of any combination of the physical components disclosed in FIG. 7.

In the example of FIG. 7, the physical computing device 700 includes a memory 702 which may include one, some, or all, of random access memory (RAM), non-volatile memory (NVM) 704 such as NVRAM for example, read-only memory (ROM), and persistent memory, one or more hardware processors 706, non-transitory storage media 708, UI device 710, and data storage 712. One or more of the memory components 702 of the physical computing device 700 may take the form of solid state device (SSD) storage. As well, one or more applications 714 may be provided that comprise instructions executable by one or more hardware processors 706 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
obtaining information about a first pre-defined implementation of a QUBO (quadratic unconstrained binary optimization) problem configured for execution on a gate-based device;
obtaining information about a second pre-defined implementation of the QUBO problem configured for execution on an annealing device;
receiving information about a QUBO job that is to be executed;
identifying first hardware and second hardware that are available to execute the QUBO job, and the first hardware is different from the second hardware;
using the information about the first and second pre-defined implementations of the QUBO problem to generate respective predictions concerning performance of the QUBO job on the first hardware and the second hardware;
comparing the predictions; and
based on the comparing, selecting one of the first hardware and the second hardware for execution of the QUBO job.

2. The method as recited in claim 1, wherein the first hardware comprises a gate-based device operable to execute a quantum circuit.

3. The method as recited in claim 1, wherein the second hardware comprises an annealing device that comprises a quantum annealing device, or a simulated annealing device.

4. The method as recited in claim 1, wherein the first hardware and the second hardware are both elements of a single heterogeneous computing infrastructure.

5. The method as recited in claim 1, wherein each of the pre-defined QUBO problems defines a different respective combination of hardware and software.

6. The method as recited in claim 1, wherein each of the predictions indicates how closely the respective performances of the QUBO job conform with one or more requirements of a service level objective.

7. The method as recited in claim 1, wherein the QUBO job is orchestrated to whichever of a gate-based device, or an annealing device, exhibits the better predicted performance of the QUBO job.

8. The method as recited in claim 1, wherein the first hardware comprises an annealing device in a form of either a real quantum computing hardware, or a simulation engine operable to simulate quantum computing hardware.

9. The method as recited in claim 1, wherein the second hardware comprises a gate-based device in a form of either real quantum computing hardware, or a simulation engine operable to simulate quantum computing hardware.

10. The method as recited in claim 1, wherein the selecting of the hardware is performed in response to invocation of a function that specifies a set of elements of the QUBO job, and the elements of the QUBO problem comprise [1] a set of constraints to be satisfied in an optimization of a solution to the QUBO job, and [2] service level objective constraints.

11. A non-transitory storage medium having stored therein instructions that are executable by one or more hardware processors to perform operations comprising:
obtaining information about a first pre-defined implementation of a QUBO (quadratic unconstrained binary optimization) problem configured for execution on a gate-based device;
obtaining information about a second pre-defined implementation of the QUBO problem configured for execution on an annealing device;
receiving information about a QUBO job that is to be executed;
identifying first hardware and second hardware that are available to execute the QUBO job, and the first hardware is different from the second hardware;
using the information about the first and second pre-defined implementations of the QUBO problem to generate respective predictions concerning performance of the QUBO job on the first hardware and the second hardware;
comparing the predictions; and
based on the comparing, selecting one of the first hardware and the second hardware for execution of the QUBO job.

12. The non-transitory storage medium as recited in claim 11, wherein the first hardware comprises a gate-based device operable to execute a quantum circuit.

13. The non-transitory storage medium as recited in claim 11, wherein the second hardware comprises an annealing device that comprises a quantum annealing device, or a simulated annealing device.

14. The non-transitory storage medium as recited in claim 11, wherein the first hardware and the second hardware are both elements of a single heterogeneous computing infrastructure.

15. The non-transitory storage medium as recited in claim 11, wherein each of the pre-defined QUBO problems defines a different respective combination of hardware and software.

16. The non-transitory storage medium as recited in claim 11, wherein each of the predictions indicates how closely the respective performances of the QUBO job conform with one or more requirements of a service level objective.

17. The non-transitory storage medium as recited in claim 11, wherein the QUBO job is orchestrated to whichever of a gate-based device, or an annealing device, exhibits the better predicted performance of the QUBO job.

18. The non-transitory storage medium as recited in claim 11, wherein the first hardware comprises an annealing device in a form of either a real quantum computing hardware, or a simulation engine operable to simulate quantum computing hardware.

19. The non-transitory storage medium as recited in claim 11, wherein the second hardware comprises a gate-based device in a form of either real quantum computing hardware, or a simulation engine operable to simulate quantum computing hardware.

20. The non-transitory storage medium as recited in claim 11, wherein the selecting of the hardware is performed in response to invocation of a function that specifies a set of elements of the QUBO job, and the elements of the QUBO problem comprise [1] a set of constraints to be satisfied in an optimization of a solution to the QUBO job, and [2] service level objective constraints.
